(19) United States
(12) Patent Application Publication
(10) Pub. No.: US 2020/0074500 A1
(43) Pub. Date: Mar. 5, 2020

(54) MULTI-DIMENSIONAL FORECASTING

(71) Applicant: Microsoft Technology Licensing, LLC, Redmond, WA (US)

(72) Inventors: Yue Huang, Sunnyvale, CA (US); He Ren, Palo Alto, CA (US); Christopher David Erbach, Palo Alto, CA (US); Vikram Shukla, Fremont, CA (US); Elise Georis, San Francisco, CA (US); Mindaou Gu, Sunnyvale, CA (US); Alexandros Ntoulas, San Francisco, CA (US)

(21) Appl. No.: 16/118,274

(22) Filed: Aug. 30, 2018

(51) Int. Cl. G06Q 30/02; G06Q 10/04

(52) U.S. Cl. CPC G06Q 30/0246; G06Q 10/04; G06Q 30/0248; G06Q 30/0275

(57) ABSTRACT

Techniques for generating a multidimensional forecast are provided. In one technique, multiple segments are generated, each comprising a different set of attribute values. For each segment, a set of prior content requests for the segment is determined based on historical data, a forecasted number of content requests is determined based on the set of prior content requests, and the forecasted number of content requests is stored in association with a set of attribute values corresponding to the segment. A request is received to forecast performance of a content delivery campaign based on a particular set of attribute values. In response to receiving the request, multiple segments that share the particular set of attribute values are identified. The forecasted number of content requests associated with each segment of the multiple segments are aggregated to generate aggregated performance data. A portion of the aggregated performance data is caused to be displayed.

### TECHNICAL FIELD

The present disclosure relates generally to efficient and accurate performance forecasting and, more particularly, to multi-dimensional forecasting.

### BACKGROUND

Forecasting performance of an online content delivery campaign is difficult for multiple reasons. One such reason is accuracy: while overall online activity may have certain patterns, online behavior of individual users and segments of users may change significantly over time and might not exhibit any noticeable pattern. Thus, forecasting performance of a relatively targeted content delivery campaign may have huge errors, such as 5×. For example, if a forecasted performance is one hundred units, then the actual performance is too often twenty units or five hundred units.

Another reason forecasting performance is difficult is responsiveness. Users of forecasting services expect forecasts to be generated in real-time (or near real-time). In order to obtain an accurate forecast in near real-time, a significant amount of data needs to be processed on-the-fly. There are many factors and different types of information that may be leveraged to produce an accurate forecast, but not all of such factors and information are currently processed in real-time.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a diagram that depicts a workflow for forecasting campaign performance, in an embodiment;

FIG. 3 is a chart that depicts an example seasonal pattern in past content requests and an example prediction of future content requests based on the seasonal pattern, in an embodiment;

FIG. 4 is a chart that depicts an example seasonal pattern with a trend in past content requests and an example prediction of future content requests based on the trend, in an embodiment;

FIG. 5 is a diagram that depicts an example moving window corresponding to particular time period, in an embodiment;

FIG. 6 is a screenshot of an example user interface that is provided by content provider interface and rendered on a computing device of a content provider, in an embodiment;

FIG. 7 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for forecasting performance of a content delivery campaign is provided. Each past user interaction or content request initiated by a user is tracked and associated with a user profile of the user. A segment is created for each unique set of dimension values corresponding to one or more users. Segment-level statistics are gathered and stored and leveraged at runtime to respond to forecast requests from content providers that desire to see a forecast of how a hypothetical content delivery campaign might perform. Each forecast request may involve identifying multiple segments and retrieving segment-level statistics associated with each identified segment.

Embodiments described herein represent an improvement in computer-related technology. An improvement includes increasing the accuracy of computer-generated forecasts while performing the computer-generated forecasts and returning the results in near real-time. In this way, a content provider can make one or more real-time adjustments to a prospective content delivery campaign and see any effects of those adjustments on the most recent forecast immediately.

### System Overview

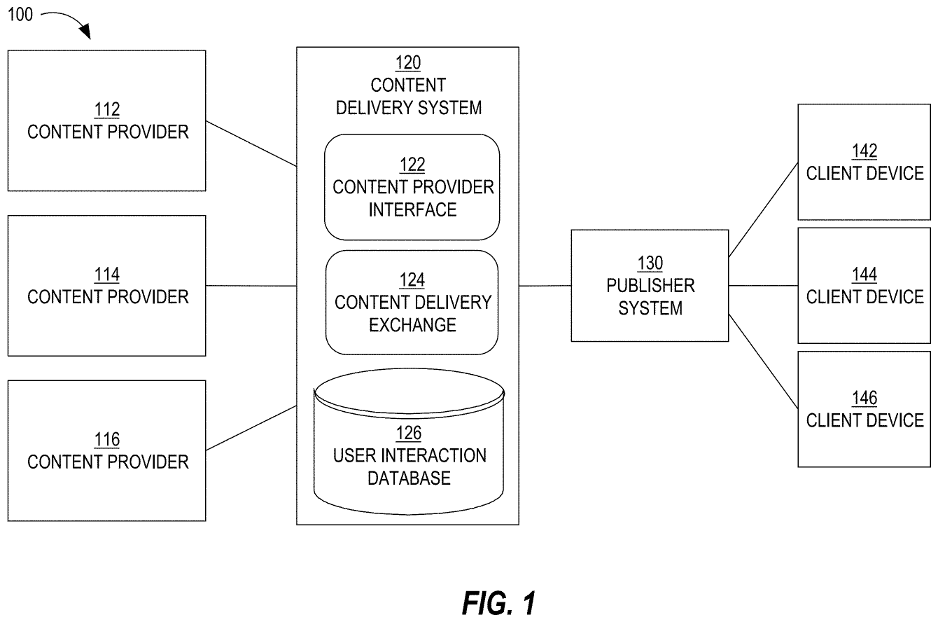

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery system 120 through, for example, content provider interface 122. An example of content provider interface 122 is Campaign Manager™ provided by LinkedIn. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount (also referred to a “resource reduction amount”) that indicates how much the corresponding content provider is willing to be charged for each impression, click, or other action. For example, a CPM campaign may bid five cents for an impression (or, for example, $2 per 1000 impressions), a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content item summaries, across client devices 152-156 (and other client devices not depicted). For example, content delivery system 120 determines whether a content item summary that content delivery exchange 124 delivers is presented at (e.g., displayed by or played back at) a client device. Such an “event” is referred to as an “impression.” As another example, content delivery system 120 determines whether a content item summary that exchange 124 delivers is selected by a user of a client device. Such a “user interaction” is referred to as a “click.” Content delivery system 120 stores such data as user interaction data, such as an impression data set and/or a click data set. Thus, content delivery system 120 may include a user interaction database 128. Logging such events allows content delivery system 120 to track how well different content items and/or campaigns perform.

For example, content delivery system 120 receives impression data items, each of which is associated with a different instance of an impression and a particular content item summary. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, a click data item may indicate a particular content item summary, a date of the user selection, a time of the user selection, a particular publisher or source (e.g., onsite v. offsite), a particular client device that displayed the specific content item, and/or a user identifier of a user that operates the particular client device. If impression data items are generated and processed properly, a click data item should be associated with an impression data item that corresponds to the click data item. From click data items and impression data items associated with a content item summary, content delivery system 120 may calculate a CTR for the content item summary.

### User Segments

As noted above, a content provider may specify multiple targeting criteria for a content delivery campaign. Some content providers may specify only one or a few targeting criteria, while other content provides may specify many targeting criteria. For example, content delivery system 120 may allow content providers to select a value for each of twenty-five possible facets. Example facets include geography, industry, job function, job title, past job title(s), seniority, current employer(s), past employer(s), size of employer(s), years of experience, number of connections, one or more skills, organizations followed, academic degree(s), academic institution(s) attended, field of study, job function, language, years of experience, interests, and groups in which the user is a member.

In an embodiment, in order to provide an accurate forecast, performance statistics are generated at a segment level, where each segment corresponds to a different combination of targeting criteria, or a different combination of facet-value pairs. Some segments may be associated with multiple users while other segments may be associated with a single user. Because the number of different possible combinations of facet-value pairs is astronomically large, the number of segments is limited to segments/users that have initiated a content item selection event in the last N number of days, such as a week, a month, or three months.

### Forecasting Workflow

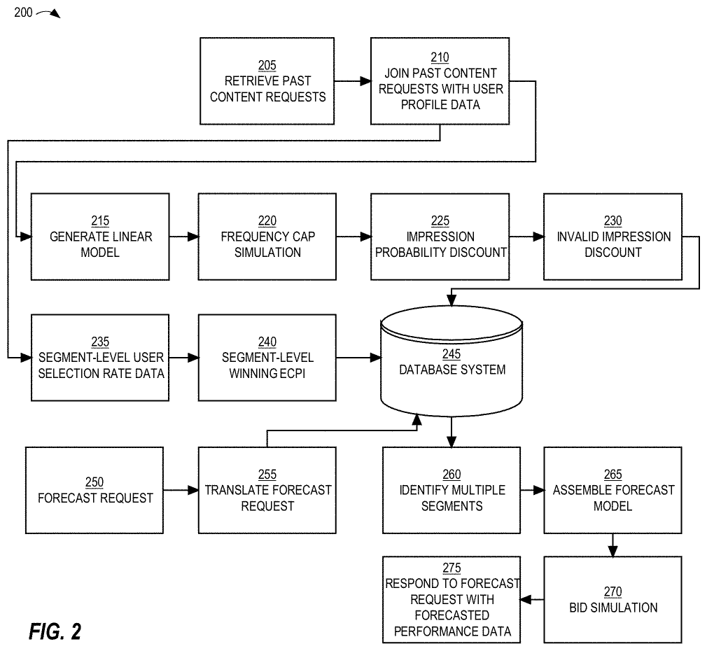

FIG. 2 is a diagram that depicts a workflow 200 for forecasting campaign performance, in an embodiment. Workflow 200 includes an offline portion and an online portion. While workflow 200 depicts blocks in a certain order and the blocks are described in a certain order, at least some these blocks may be performed in a different order or even concurrently relative to each other. Also, workflow 200 may be implemented by one or more components of content delivery system 120 or a system that is communicatively coupled to content delivery system 120. For example, the online portion of workflow 200 may be activated by input to content provider interface 122.

At block 205 of workflow 200, past content requests that initiated content item selection events are retrieved. These content requests will be used to determine (or estimate) a forecast of one or more future content requests. The content requests that are retrieved may be limited to the last N days, where N is any positive integer, such as seven days, fourteen days, twenty-eight days, thirty days, or half a year. Some of the retrieved content requests may originate from the same user. If two or more of the retrieved content requests originated from the same user, some of those content requests may have originated from one computing device (e.g., a tablet computer of the user) while others may have originated from another computer device (e.g., a laptop computer of the user). The number of users reflected in the retrieved content requests may be relatively low relative to the total number of user profiles to which content delivery system 120 has access. In other words, there may be many users that have not visited publisher system 130 (or that have visited other publisher systems that are communicatively connected to content delivery system 120).

At block 210, the retrieved content requests are joined with user profile data. “Joining” in block 210 involves identifying, for each retrieved content request, the user profile of the user that initiated the content request is retrieved from a profile database, which may be accessible to content delivery system 120. If a user profile has already been retrieved for a prior retrieved content request, then that user profile may be available in memory so that a persistent storage read may be avoided. Once a user profile is retrieved, the targetable profile attribute values are retrieved from the user profile and stored in a segment-level profile. If a segment has already been created for the set of extracted profile attribute values (whether because the retrieved content request pertains to the same user or to a different user that has the same set of targetable profile attribute values), then information about the retrieved content request is aggregated with other content requests pertaining to the segment.

In an embodiment, a forecast is made for a particular period. If a forecast request is for longer than the particular period, then the forecast data of a segment is increased accordingly. For example, if the particular period is a week and the requested forecast period is a month, then the forecast data (e.g., number of impressions, if forecasted number of impressions is requested) may be multiplied by 4 or 4.3.

### Seasonality and Trend

At (optional) block 215, a content request seasonality and/or trend is determined. Seasonality and/or trend may be determined for different groups of users, such as users in the United States, users with a technical degree, users with certain job titles, or any combination thereof.

In an embodiment, seasonal behavior of the inventory of content items is estimated by averaging over previous content requests for that season. For example, for daily time series data, the seasonal effect of Monday is an average of content request counts, each count for a previous Monday in the historical content request data. For pacing (which is described in more detail below), a smaller granularity of time series data is calculated. For example, for per-15 minutes time series data, the seasonable effect of Monday at 10:00 am is an average of content request counts, each count for a previous Monday from 9:45 am to 10:00 am in the historical content request data.

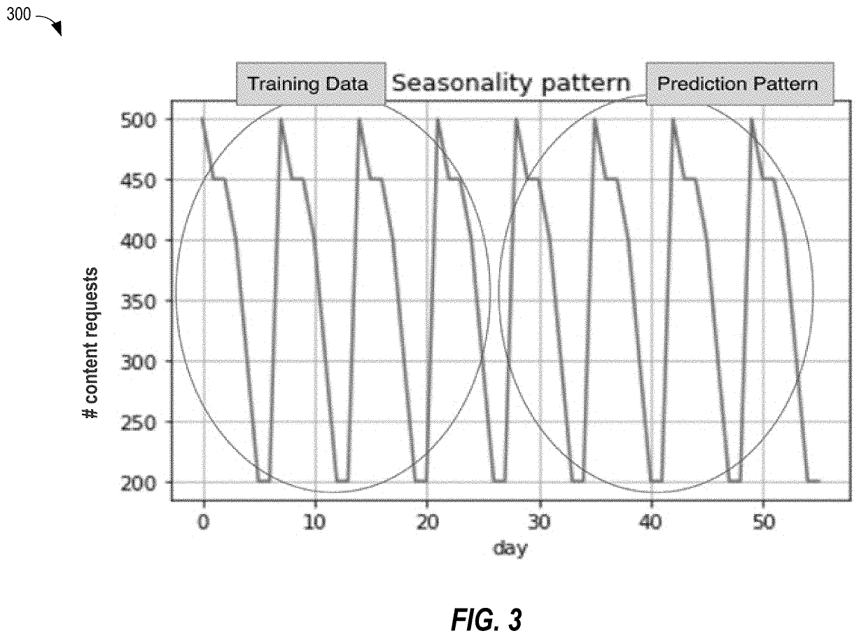

FIG. 3 is a chart 300 that depicts a seasonal pattern in the training data (indicating a number of content requests for each day) that spans approximately 25 days, which is used to predict a similar pattern in days subsequent to the training data.

A trend may be negative, positive, or neutral. A negative trend implies that the number of content requests that content delivery system 120 receives is decreasing over time, while a positive trend implies that the number of content requests that content delivery system 120 receives is increasing over time. A trend data point for a segment may be a single numeric value, such as 1.1. Forecasted values of types other than impressions may be derived from a forecasted number of impressions.

Block 215 may involve training a linear trend model based on, for example, the previous four to eight weeks of content requests and validating the linear trend model based on, for example, the previous one to four weeks of content requests, after which the coefficient reflecting the trend is stored. For example, a linear trend model may fit a linear regression over time:

Y(x)=b₀+b₁*x

where b₁ and b₀ are derived from:

$${b}_{1} = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}}$$

$${b}_{0} = \overline{y} - {b}_{1} \overline{x}$$

Machine learning techniques other than regression may be used to generate a linear trend model.

In an embodiment, a single global trend is calculated and used to forecast a number of content requests for each of multiple segments. Alternatively, a separate trend is calculated for each segment or different sets of content requests, such as content requests from different channels, different types of content delivery campaigns, etc.

If a trend is detected over the last time period (e.g., last N days), then a forecast number of impressions is generated based on presuming that the trend will continue. For example, if a positive trend of 5% is detected and the original forecasted number of impressions is 100, then the forecasted number of impressions will be 105. If a negative trend is detected, then the forecasted number of impressions will be less than the original forecasted number of impressions.

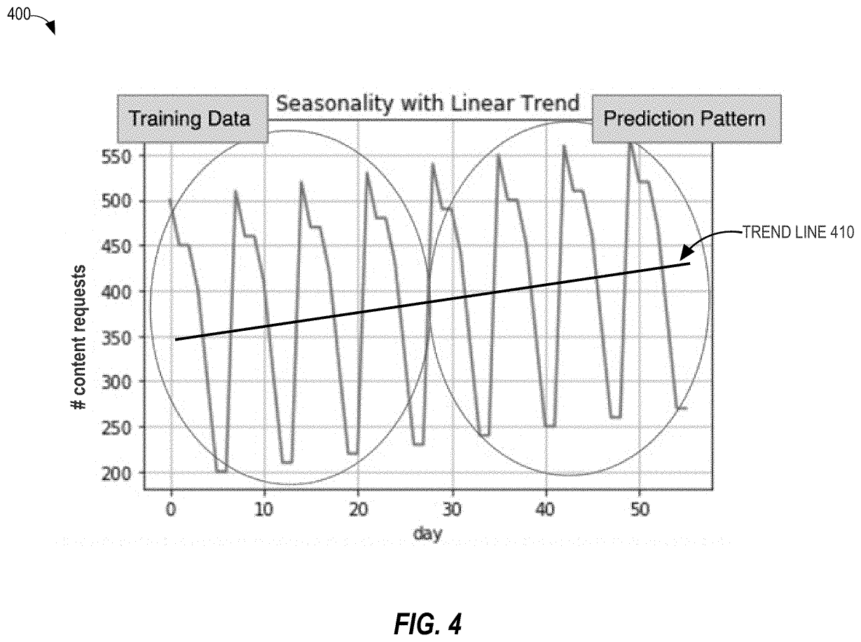

FIG. 4 is a chart 400 that depicts a seasonal pattern with a trend in the training data (indicating a number of content requests for each day) that spans approximately 28 days, which is used to predict a similar seasonal pattern and similar trend in days subsequent to the training data. With seasonality data and a linear trend, the weekly and daily pattern and natural growth and decline in each target segments may be captured. In the depicted example, trend line 410 illustrates a positive trend.

In an embodiment, a trend is determined for multiple time periods. For example, trend data that is calculated for a particular segment may include trend data for a first time period (e.g., a week) and trend data for a second time period (e.g., a month).

The forecast data (e.g., number of forecasted content requests, number of forecasted content requests that will result in an impression, or number of forecasted content requests that will result in a valid impression, as described in more detail below) for each segment is stored in database system 245. An example of database system 245 is a Pinot database. The forecast data may be based on the seasonal and/or trend information calculated above. For each segment, the forecast data may be based on (a) all previous seven-days of content request data for all users of the segment (where the 7 days of data is the previous four Monday's average content requests, the previous four Tuesday's average content request data, etc.); (b) all previous 14 days of content request data for all users of the segment; or (c) all previous 28 days of content request data for all users of the segment. Time periods unrelated to weeks and/or months may be used instead.

### FCAP Simulation

At block 220, a frequency cap simulation is applied to content requests associated with each user. A frequency cap is a restriction on the number of times a user is exposed to a particular content item, to any content item from a particular campaign, to any content item from a group of content delivery campaigns, and/or to any content item from a content provider. A frequency cap is enforced by content delivery system 120. A frequency cap may be established by an administrator of publisher system 130 or of content delivery system 120, or by a content provider. A frequency cap may be established on a per-content item basis, a per-campaign basis, a per-campaign group basis, and a per-content provider basis. Thus, multiple frequency caps may be applied to each user's set of forecasted content requests.

In an embodiment, different types of content items or different types of content delivery campaigns are associated with different frequency caps. For example, for content items of the text type and content items of the dynamic type, there is a maximum of twenty impressions per campaign in the past 24 hours and maximum of one impression per campaign in the past 30 seconds per member. For content items of the sponsored update type, there is a maximum of one impression per content provider in the past 12 hours per member and a maximum of one impression per activity in the past 48 hours per member.

Applying a frequency cap may result in removing one or more content requests from a user's forecast of content requests. For example, if a particular user is forecasted to visit publisher system 130 four times in a seven-day period and a particular frequency cap states that a user is able to be presented with a particular content item no more than three times in any seven-day period, then one of the four forecasted visits is removed from the forecast.

In an embodiment, a queue is maintained with a moving window of a particular period of time (e.g., 48 hours). Content request data is grouped by user identifier and the timestamps of each user's visit are extracted (which timestamp may be represented by a content request event timestamp). Then, a user visiting timestamp (corresponding to a unique user visit, or “visiting instance”) of a particular user is placed into the queue. If the set of timestamps in the queue violate any frequency cap rule, then the most recently added visiting instance is removed from the queue. If there is no violation, then insert this visiting instance remains the queue. This process of adding the next visiting instance (of the particular user) to the queue is repeated until there are no more visiting instances for that particular user. The final queue size for that particular user is the simulated content request count after frequency cap simulation. The above process is repeated for each user in order to get the right simulated content request count.

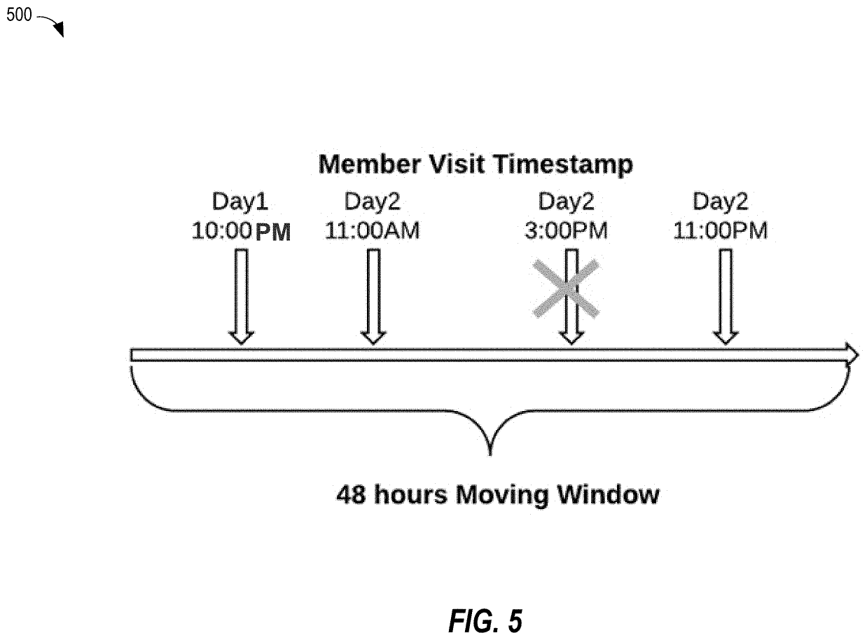

FIG. 5 is a diagram that depicts an example moving window 500 corresponding to 48 hours, in an embodiment. Moving window 500 includes four data points, each corresponding to a different content request initiated by (or a different web visit from) a particular user/member. The timestamp of each content request is used to place a corresponding entry or data point in moving window 500. In this example, a frequency cap is that a user is not allowed to view the same content item more than three times in a 48-hour period. Therefore, applying this frequency cap to the four content requests causes one of the four content requests to be deleted.

A result of block 220 is, for each user of multiple users, a set of content requests that the user is forecasted to originate and that will not be ignored or removed as a result of one or more frequency caps.

### Impression Probability

In some situations, even though a content item is selected as a result of a content item selection event, that content item is not presented to the target user. For example, one or more content item selection events are conducted to identify one or more content items that will be presented if a user scrolls down a feed on a (e.g., “home”) web page. If the user does not scroll down the feed, then those content items will be presented (e.g., displayed).

At block 225, an impression probability is calculated and stored. An impression probability is the probability of an impression after a corresponding content item selection event results in selecting a content item.

In an embodiment, a single impression probability is calculated for past content item selection events. This impression probability may be applied later when multiple segment-level statistics are aggregated in response to a forecast request initiated by a content provider.

In a related embodiment, different impression probabilities are calculated for different sets of facets or attributes. For example, different types of content delivery campaigns (e.g., text ads, dynamic ads, sponsored updates) may be associated with different impression probabilities, different content delivery channels (e.g., web, mobile) may be associated with different impression probabilities, and different locations on a web page and/or different positions with a feed may be associated with different impression probabilities. An impression probability may be stored and applied later, such as in response to a forecast request initiated by a content provider.

In a related embodiment, an impression probability is calculated for each segment. Such a calculation may involve loading content requests from a certain period of time (e.g., last 28 days) and loading impression events from that certain period of time. These two data sets are merged and grouped by user identifier or by segment. An impression probability for each user or segment may then be calculated as follows:

P_{auction to impression}(segment)=Σimpressionse_{segment}/Σcontent item selection eventsse_{segment}

In other words, a probability of an impression for a particular segment is a ratio of (1) the number of impressions to the particular segment to (2) the number of content item selection events to which users in the segment initiated. A segment-level impression probability may be stored in association with segment-level forecast data and applied later, such as in response to a forecast request initiated by a content provider.

A result of block 225 is, for each segment of multiple segments, a set of content requests that are (1) forecasted to originate from users in the segment and (2) predicted to result in an impression.

### Invalid Impression Discount

In some situations, an impression event that is received is ultimately determined to be invalid. For example, if a user scrolls down a feed and a content item in the feed is displayed, then the user's computing device generates an impression event for that display, transmits the impression event to content delivery system 120, which stores the impression event. Then, if the user scrolls back up the feed and views the content item again, the computing device generates and transmits another impression event. That subsequent impression event is considered a duplicate event, marked invalid, and becomes non-chargeable.

As another example, if an impression event is generated for a content item selection event that occurred more than, for example, 30 minutes after the content item selection event, then that impression event is marked invalid. This may occur if a client device caches a content item (e.g., that has been received from content delivery system 120, but has not yet been displayed) and later displays the content item when a user of the client device scrolls to a position in a feed or web page where the content item is located.

At block 230, an invalid impression factor is generated and stored. An invalid impression factor may be generated based on a ratio of (1) the number of invalid impression events that occurred during a period of time to (2) all impression events (both valid and invalid) that occurred during that period of time. The invalid impression factor may be applied later, such as in response to a forecast request initiated by a content provider. Conversely, instead of generating an invalid impression factor, a valid impression probability is generated based on a ratio of (1) the number of valid impression events that occurred during a period of time to (2) all impression events (both valid and invalid) that occurred during that period of time.

In a related embodiment, different invalid impression factors (or valid impression probabilities) are generated for different sets of facets or attributes. For example, different types of content delivery campaigns (e.g., text ads, dynamic ads, sponsored updates) may be associated with different invalid impression factors, different content delivery channels (e.g., web, mobile) may be associated with different invalid impression factors, and different locations on a web page and/or different positions with a feed may be associated with different invalid impression factors. Again, an invalid impression factor may be stored and applied later, such as in response to a forecast request initiated by a content provider.

In a related embodiment, an invalid impression factor is calculated for each segment. An invalid impression factor for each user or segment may then be calculated as follows:

P_{invalid_impression}(segment)=Σinvalid_impressionse_{segment}/Σall_impressions_{segment}

In other words, a probability of an invalid impression for a particular segment is a ratio of (1) the number of invalid impressions to users in the particular segment to (2) the total number of impressions to users in the particular segment. A segment-level invalid impression factor may be stored in association with segment-level forecast data and applied later, such as in response to a forecast request initiated by a content provider.

A result of block 230 is, for each segment of multiple segments, a set of content requests that are (1) forecasted to originate from users in the segment and (2) predicted to result in a valid impression.

After block 230, per-segment level forecast data includes a number of forecasted content requests for the corresponding segment, such as 43 or 8. The forecasted number may be a number of content requests that are forecasted to originate from (or be initiated by) users in the segment, a number of such content requests that will result in an impression, or a number of such content requests that will result in a valid impression.

### User Selection Rate

At block 235, a segment-level user selection rate is calculated for each segment. A user selection rate of a user is a rate at which the user selects (or otherwise interacts with) a content item that is presented to the user. (A user selection rate of a content item is a rate at which users select (or otherwise interacts with) the content item when the content item is presented to users.) An example of a user selection rate is a click-through rate (or CTR).

A segment-level user interaction rate may be calculated by totaling the number of user interactions (e.g., clicks) by users in a particular segment and dividing by the total number of (e.g., valid) impressions to users in the particular segment. The click events and the impression events that are considered for the calculation may be limited to events that occurred during a particular period of time, such as the last four weeks.

Alternatively, for each segment, the corresponding raw values of the numerator (i.e., number of user interactions) and of the denominator (i.e., number of impressions) are stored.

Instead of storing the user selection rate (or the raw values) on a per-segment level, a prediction model that predicts a user selection rate based on user characteristics is used to calculate a user selection rate for a segment. In a related embodiment, some segments have actual user selection rates (i.e., based on user interaction and impression values) while some segments have predicted user selection rates.

Block 235 is optional. If the forecasted campaign performance only involves impressions, then block 235 is not necessary. However, if forecasted campaign performance includes a forecast of one or more types of user selections (e.g., clicks, shares, likes, or comments), then block 235 is performed.

### Winning ECPI

At block 240, a segment-level winning ecpi is calculated for each segment. An “ecpi” refers to an effective cost per impression. The ecpi is an amount the winning content provider pays content delivery system 120 for causing a valid impression to be presented (e.g., displayed) to a user that is targeted by a content delivery campaign initiated by the content provider. In a first price auction, the winner pays the winning bid. In a second price auction, the winner pays the second highest bid instead of the winning bid.

Content delivery system 120 stores (or has access to) data about past content item selection events. Such data may indicate, for each content item selection event, campaign identifiers of campaigns that were considered in the content item selection event, a timestamp indicating when the content item selection event occurred, a user/member identifier of a user that initiated the content item selection event, the winning campaign, the winning bid, the second-highest bid (in case of a second price auction), etc.

A segment-level winning ecpi data is generated by collecting all the winning bids (or second-highest bids, in case of a second price auction) from all content item selection events (during a particular period of time, such as the last two weeks) in which users in the corresponding segment participated. Statistics about the collected bids may be calculated or organized (e.g., a winning bid distribution) to allow for real-time processing when a forecast request from a content provider is received. Alternatively, each the winning ecpi data point is stored in association with the corresponding segment. The statistics are used to perform bid simulation in response to a forecast request from a content provider, as described in more detail below.

As depicted in workflow 200, blocks 235 and 240 may be performed in parallel or concurrently with blocks 215-230.

### Online Workflow

As noted previously, workflow 200 includes an online portion that includes block 250, which involves a content provider (or a representative thereof) causing a forecast request to be transmitted from a computing device of the content provider to content delivery system 120. A forecast request includes multiple data items, such as targeting criteria and a bid amount. Some data items in a forecast request may be default values, such as start date (which may automatically be filled in with the current date) and forecast period (e.g., weekly v. monthly).

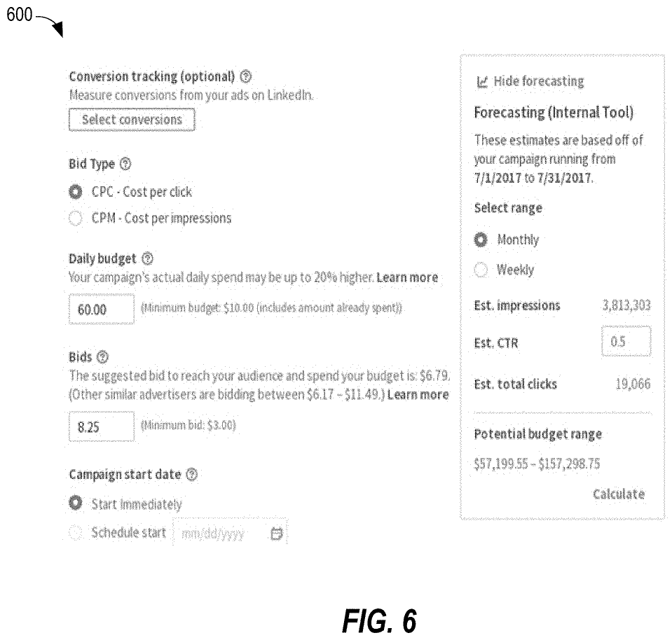

FIG. 6 is a screenshot of an example user interface 600 that is provided by content provider interface 122 and rendered on a computing device of a content provider, in an embodiment. UI 600 includes an option to select a bid type (e.g., CPC or CPM), a text field to enter a daily budget, a text field to enter bid amount (which text field may be pre-populated with a “suggested” bid amount), and an option to establish a start date, whether immediately or some date in the future. UI 600 also includes a forecasting portion that allows a user to select a forecast period (a monthly forecast in this example) and that displays an estimated number of impressions, an estimated user selection rate (or CTR), and an estimated number of clicks. In an embodiment, if the bid type is CPM, then an estimated CTR and an estimated number of clicks are not calculated or presented to the user. Alternatively, such calculations and presentations are performed even for CPM campaigns.

At block 255, the forecast request is translated into a query that database system 245 “understands.” Such a translation may involve changing the format of the data in the forecast request. An example forecast request is as follows:
d2://adForecasts?campaignType=SPONSORED UPDATES&q=supplyCriteria&target=(facets:List((name:geos,values:List(na.us)),(name:langs,values:List(en)),
(name:skills,values:(java)),
(name :title,values: (! manager)))&timeRange=(end: 1501570800000, start:1500534000000)

This forecast request is to forecast impressions and clicks for a proposed content delivery campaign that targets users who reside in the United States and who know Java or Python and whose title does not include “Manager.”

An example of a query to which the above example forecast request is translated is as follows:
select sum(lick),
sum(impression),
sum(invalid_impression),
sum(su_request), sum(log _ecpi), sum(sq_log_ecpi),
sum(sum_request_d1), sum(su_request_d2), . . . from suForecast where dimension_skill in (“1000”, “500”) and dimension_geo in (“na.us”) and dimension_title NOT in (“305”)

In this example, the three dimensions of skill, geography, and title are considered. For any segment that satisfies each of the value(s) of each dimension, that segment is identified, as described in block 260.

At block 260, database system 245 identifies multiple segments based on the targeting criteria indicated in the forecast request and reflected in the query. For example, if the targeting criteria includes criterion A, criterion B, and criterion C with a conjunctive AND, then all segments/users that have each of these criteria are identified, along with their corresponding forecast data. The corresponding forecast data may include, for each identified content request, a count of forecasted content requests, trend data for the segment (if any exists), segment-level user selection rate, and segment-level winning ecpi data.

At block 265, a forecast model is assembled based on the forecast data associated with each identified segment from block 260. If the forecast request requests a forecast of (e.g., valid) impressions, then the impression count associated with each identified segment is retrieved and the retrieved impression counts are aggregated to generate an aggregated impression count for the proposed content delivery campaign. If the forecast request requests a forecast of user selections (e.g., clicks), then, for each identified segment, an impression count associated with the identified segment is retrieved and multiplied by a user selection rate associated with the identified segment to calculate a forecasted number of user selections for that identified segment. The forecasted numbers of user selections are aggregated to generate an aggregated user interaction count for the proposed content delivery campaign. Alternatively, for each segment, a number of clicks is calculated offline and stored in a database. However, this approach requires extra storage.

At block 270, bid simulation is performed to determine a number of forecasted content requests that the proposed content delivery campaign will win based on a specified bid indicated in the forecast request. To perform bid simulation, for each segment that is identified based on the forecast request, the corresponding segment-level winning ecpis are retrieved. A bid distribution may be constructed based on each of the individual data points, each data point corresponding to a different winning ecpi. For example, in the bid distribution, an ecpi may be determined for each of multiple percentiles, such as a 10^{th} percentile, a 20^{th} percentile, a 30^{th} percentile, etc. Thus, if a specified bid for a not-yet-initiated content delivery campaign is $3.10 and the 20^{th} percentile is associated with $3.10, then it is estimated that a bid of $3.10 would result in winning 20% of content item selection events that result from content requests that are forecasted to originate from users in the identified segments. As another example, an ecpi distribution is generated for each segment. Each winning bid (or second-highest bid) may be assigned to a range of winning bids. For example, a number of content item selection events where the winning bid (or second-highest bid) was between $3.00 and $3.25 is determined and stored, a number of content item selection events where the winning bid (or second-highest bid) was between $3.25 and $3.50 is stored, and so forth.

Alternatively, block 270 is performed as follows, where the distribution of winning ecpis is approximated using a lognormal distribution, such as:

Log(topEcpi)˜N(μ,σ²)

which means that Log(topEcpi) is subject to the normal distribution on the right. “topEcpi” is a random variable of winning ecpi, which stands for effective cost per impression. To estimate parameters μ and σ for the online flow, the following maximum likelihood method may be used:

$$\hat{μ} = \frac{{\sum }_{k} ln {x}_{k}}{n}$$

$${\hat{σ}}^{2} = \frac{{\sum }_{k} {( ln {x}_{k} - \hat{μ} )}^{2}}{n}$$

where k is a sequence number; xₖ is the k-th ecpi; n is the total number of user requests; Σₖ ln xₖ is pre-calculated in a (e.g., Hadoop) workflow and pushed to database system 245; and σ may be calculated by σ²=(l/n)Σₖ(ln xₖ)²−μ² and ρₖ(ln xₖ)² is pre-calculated in the workflow and pushed to database system 245; therefore a may be obtained quickly since μ is available in the previous step.

The ecpi of the proposed content delivery campaign may be used to calculate the cumulative probability from the distribution fitted earlier. To align with bid suggestion and content item selection events, the proposed campaign ecpi equals (a) CTR_{average}*proposed bid if the proposed campaign is a CPC campaign or (b) proposed bid/1000 if the proposed campaign is a CPM campaign.

Bid discount factor=ecpiDistribution·cumulativeProbability(Log(Ecpi))

The bid discount factor represents the percentage of the impressions this campaign would win from content item selection events. This bid discount factor is applied to the forecast data on all target dimensions. Thus, the forecast for a proposed content delivery campaign may be formulated as follows:

Forecast=F_{Target}*Impression_discount*Fcap_distribution*Invalid_Impression_discount*Bid_distribution

At block 275, a result of the forecast request is returned to the content provider that initiated the forecast request. The result indicates a forecasted performance data regarding the proposed content delivery campaign. Examples of forecasted performance data include an estimated number of impressions, an estimated number of clicks, a

A content provider may adjust the bid amount in the user interface to see how a different bid value will affect the number of content item selection events that are forecasted to be won. Thus, a content provider, in the same (e.g., web) session with content provider interface 122, provide multiple bid values. Each unique set of targeting criteria and bid amount may result in very different performance data of the proposed content delivery campaign. For example, increasing a bid amount by a small amount (e.g., 5%) may result in significant increase (e.g., 20%) in the number of (e.g., valid) impressions that are forecasted to result.

In an embodiment, adjusting a bid amount does not result in accessing database system 245 again. Instead, the same bid distribution that was used to forecast campaign performance based on a prior bid amount and a set of targeting criteria (or attribute values) is used again for an adjusted (or second) bid amount, as long as the targeting criteria has not changed.

However, a content provider changing one or more targeting criteria may have a significant impact on forecasted performance of a proposed content delivery campaign. Changing any targeting criterion (or attribute value) results in sending a different query to database system 245, which will (likely) identify a different set of segments than were identified based on the previous set of target criteria indicated in a prior forecast request from the content provider.

### Testing Framework

Changes may be made to one or more components of workflow 200 (whether offline portion, online portion, or both). Such changes may be made in order to increase the accuracy of future forecasts. However, it is not clear if such changes will actual increase the accuracy of future forecasts.

In an embodiment, a testing framework is implemented where changes to components of workflow 200 are made offline and used to make forecasts for past or present (e.g., active) content delivery campaigns. For example, a copy of a to-be-changed component is created and one or more changes to that copy are made. For example, a different fcap rule is applied, a different impression probability for certain segments is applied, and/or a different bid simulation technique is implemented. Then, a first forecast is made for a campaign that was/is already active but at a point in time before the campaign began. The first forecast is based on components of workflow 200 while a second forecast is made for the campaign, which second forecast is based on the one or more changes to one or more copies of one or more components of workflow 200. The two forecasts are compared to the actual result of the campaign (e.g., whether number of impressions, number of clicks) to determine which forecast is closer to the actual result. If the second forecast is closer to the actual result, then the one or more changes to the component(s) of workflow 200 so that future forecast requests from content providers leverage those changes. Such changes may be applied if the forecasts based on the changes are consistently (or more often) better than the forecasts that are not based on the changes.

With this testing framework, developers or administrators of workflow 200 can ask the question, “If a change was applied 7 days ago, how would the forecast have performed compared to the old forecast without the change”? Also, the testing framework allows developers to see immediately how proposed changes to workflow 200 will affect forecasts without having to wait to see how future forecasts will do relative to actual results. The testing framework may be invoked for any content delivery campaign at virtually any point in the past.

### Pacing

In an embodiment, content delivery system 120 applies pacing to content delivery campaigns. A purpose of pacing is to prevent a campaign's daily budget from being used up right away. Thus, pacing may be used to evenly use up a campaign's daily budget through a time period, such as a day.

In an embodiment, a pacing component (not depicted) of content delivery system 120 relies on workflow 200 to obtain multiple forecasts for a single time period, such as a day. If current usage of a campaign's budget exceeds a forecast of the budget's usage, then the pacing component prevents the campaign from participating in a content item selection event. In response to calling a forecasting service that relies on the online portion of workflow 200, the pacing component will receive, from the forecasting service, a forecast that corresponds to a particular time period, such as from 12:00 to 12:15 or from 12:00 to 6:45. For example, the forecasting service may generate forecasts at relatively short time increments, such as every 15 minutes. Thus, while a content provider wants to see how a proposed campaign will perform over a week or a month, the pacing component uses the forecasting service to retrieve more granular numbers, such as a how a currently active campaign will perform in the next 10-20 minutes.

The forecasting service leverages the targeting criteria of the currently active campaign to identify multiple segments in database system 245 in order to generate aggregated forecast data, which includes multiple forecast numbers over a single day, each forecast number representing a prediction of a number of content requests over a different part of the day. For example, one forecast number may be for the time period of 12:00-12:15 and another forecast number may be for the time period of 12:15-12:30. If the current time is 12:30, then the forecasting service (or the pacing component) aggregates the two forecast numbers to generate a forecast for 12:30.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

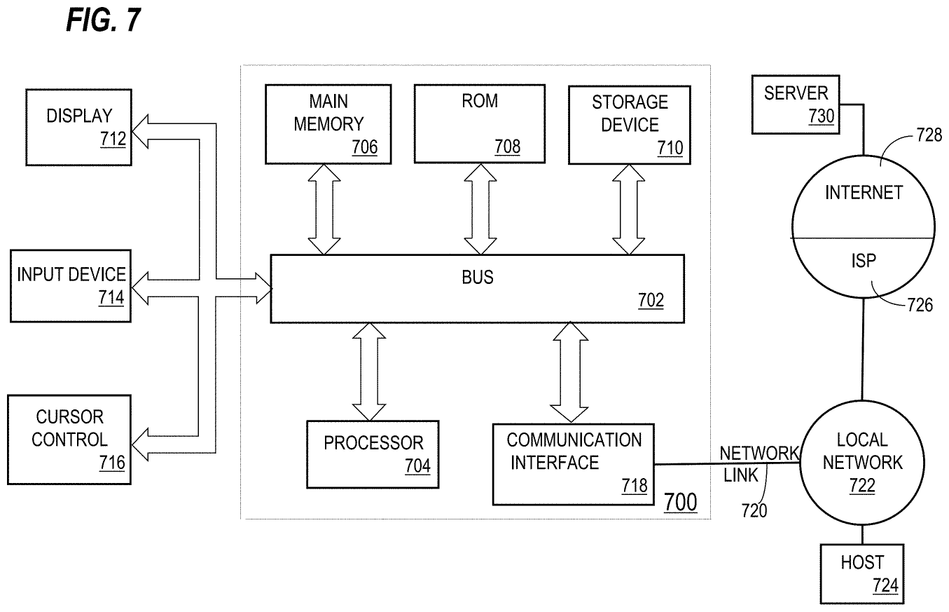

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating a plurality of segments, each of which comprises a different set of attribute values;
for each segment of the plurality of segments:
based on historical data, determining a set of prior content requests for said each segment;
determining, based on the set of prior content requests, a forecasted number of content requests;
storing, in a data store, the forecasted number of content requests in association with a set of attribute values corresponding to said each segment;
receiving a request to forecast performance of a content delivery campaign based on a particular set of attribute values;
in response to receiving the request:
based on the particular set of attribute values, identifying, from the data store, multiple segments, of the plurality of segments, that share the particular set of attribute values;
aggregating the forecasted number of content requests associated with each segment of the multiple segments to generate aggregated performance data;
causing at least a portion of the aggregated performance data to be displayed;
wherein the method is performed by one or more computing devices.

2. The method of claim 1, wherein:
determining the forecasted number of content requests for a particular segment of the plurality of segments comprises applying one or more frequency caps to the set of prior content requests for the particular segment;
applying the one or more frequency caps results in removing one or more content requests from the set of prior content requests for the particular segment prior to determining the forecasted number of content requests.

3. The method of claim 1, wherein:
determining the forecasted number of content requests for a particular segment of the plurality of segments comprises applying an impression factor to the set of prior content requests for the particular segment;
the impression factor indicates that less than all content item selection events result in an impression;
applying the impression factor results in removing one or more content requests from the set of prior content requests for the particular segment prior to determining the forecasted number of content requests.

4. The method of claim 1, wherein:
determining the forecasted number of content requests for a particular segment of the plurality of segments comprises applying an impression factor to the set of prior content requests for the particular segment;
the invalid impression factor indicates that at least some impressions are invalid;
applying the invalid impression factor results in removing one or more content requests from the set of prior content requests for the particular segment prior to determining the forecasted number of content requests.

5. The method of claim 1, further comprising:
detecting seasonality in the historical data, wherein determining the forecasted number of content requests for a particular segment of the plurality of segments is further based on the seasonality.

6. The method of claim 1, further comprising:
detecting a trend in the historical data, wherein determining the forecasted number of content requests for a particular segment of the plurality of segments is further based on the trend.

7. The method of claim 1, further comprising:
storing, in the data store, time range data that indicates, for each time range in a plurality of time ranges, a number of forecasted content requests that are predicted to be received during said each time range.

8. The method of claim 1, further comprising:
storing, in the data store, for each segment of the plurality of segments, one or more data values that indicate a user selection rate of said each segment;
in response to receiving the request:
identifying the one or more data values of each segment of the multiple segments;
based on the one or more data values of each segment of the multiple segments, calculating a particular user selection rate for the multiple segments;
aggregating the forecasted number of content requests associated with each segment of the multiple segments to generate a total number of forecasted content requests;
calculating a forecasted number of clicks based on the particular user selection rate and the total number of forecasted content requests;
wherein the aggregated performance data includes the forecasted number of clicks.

9. The method of claim 1, wherein the request indicates a first bid, the method further comprising:
for each segment of the plurality of segments, storing, in the data store, bid information that is associated with each forecasted content request that is associated with said each segment;
in response to receiving the request:
identifying the bid information associated with each segment of the multiple segments;
constructing a bid distribution based on the bid information associated with each segment of the multiple segments;
determining, based on the first bid and the bid distribution, a first number of forecasted content requests that will result in winning a content item selection event.

10. The method of claim 9, wherein the request is a first request, the method further comprising:
receiving a second request to forecast performance of the content delivery campaign based on the particular set of attribute values, wherein the second request indicates a second bid that is different than the first bid;
in response to receiving the second request:
determining, based on the second bid and the bid distribution, a second number of forecasted content requests that will result in winning a content item selection event.

11. One or more storage media storing instructions which, when executed by one or more processors, cause:
generating a plurality of segments, each of which comprises a different set of attribute values;
for each segment of the plurality of segments:
based on historical data, determining a set of prior content requests for said each segment;
determining, based on the set of prior content requests, a forecasted number of content requests;
storing, in a data store, the forecasted number of content requests in association with a set of attribute values corresponding to said each segment;
receiving a request to forecast performance of a content delivery campaign based on a particular set of attribute values;
in response to receiving the request:
based on the particular set of attribute values, identifying, from the data store, multiple segments, of the plurality of segments, that share the particular set of attribute values;
aggregating the forecasted number of content requests associated with each segment of the multiple segments to generate aggregated performance data;
causing at least a portion of the aggregated performance data to be displayed.

12. The one or more storage media of claim 11, wherein:
determining the forecasted number of content requests for a particular segment of the plurality of segments comprises applying one or more frequency caps to the set of prior content requests for the particular segment;
applying the one or more frequency caps results in removing one or more content requests from the set of prior content requests for the particular segment prior to determining the forecasted number of content requests.

13. The one or more storage media of claim 11, wherein:
determining the forecasted number of content requests for a particular segment of the plurality of segments comprises applying an impression factor to the set of prior content requests for the particular segment;
the impression factor indicates that less than all content item selection events result in an impression;
applying the impression factor results in removing one or more content requests from the set of prior content requests for the particular segment prior to determining the forecasted number of content requests.

14. The one or more storage media of claim 11, wherein:
determining the forecasted number of content requests for a particular segment of the plurality of segments comprises applying an impression factor to the set of prior content requests for the particular segment;
the invalid impression factor indicates that at least some impressions are invalid;
applying the invalid impression factor results in removing one or more content requests from the set of prior content requests for the particular segment prior to determining the forecasted number of content requests.

15. The one or more storage media of claim 11, wherein the instructions, when executed by the one or more processors, further cause:
detecting seasonality in the historical data, wherein determining the forecasted number of content requests for a particular segment of the plurality of segments is further based on the seasonality.

16. The one or more storage media of claim 11, wherein the instructions, when executed by the one or more processors, further cause:
detecting a trend in the historical data, wherein determining the forecasted number of content requests for a particular segment of the plurality of segments is further based on the trend.

17. The one or more storage media of claim 11, wherein the instructions, when executed by the one or more processors, further cause:
storing, in the data store, time range data that indicates, for each time range in a plurality of time ranges, a number of forecasted content requests that are predicted to be received during said each time range.

18. The one or more storage media of claim 11, wherein the instructions, when executed by the one or more processors, further cause:
storing, in the data store, for each segment of the plurality of segments, one or more data values that indicate a user selection rate of said each segment;
in response to receiving the request:
identifying the one or more data values of each segment of the multiple segments;
based on the one or more data values of each segment of the multiple segments, calculating a particular user selection rate for the multiple segments;
aggregating the forecasted number of content requests associated with each segment of the multiple segments to generate a total number of forecasted content requests;
calculating a forecasted number of clicks based on the particular user selection rate and the total number of forecasted content requests;
wherein the aggregated performance data includes the forecasted number of clicks.

19. The one or more storage media of claim 11, wherein the request indicates a first bid, wherein the instructions, when executed by the one or more processors, further cause:
for each segment of the plurality of segments, storing, in the data store, bid information that is associated with each forecasted content request that is associated with said each segment;
in response to receiving the request:
identifying the bid information associated with each segment of the multiple segments;
constructing a bid distribution based on the bid information associated with each segment of the multiple segments;
determining, based on the first bid and the bid distribution, a first number of forecasted content requests that will result in winning a content item selection event.

20. The one or more storage media of claim 19, wherein the request is a first request, wherein the instructions, when executed by the one or more processors, further cause:
receiving a second request to forecast performance of the content delivery campaign based on the particular set of attribute values, wherein the second request indicates a second bid that is different than the first bid;
in response to receiving the second request:
determining, based on the second bid and the bid distribution, a second number of forecasted content requests that will result in winning a content item selection event.
